(19) United States
(12) Patent Application Publication
(10) Pub. No.: US 2026/0022891 A1
(43) Pub. Date: Jan. 22, 2026

(54) WIRELESSLY TRANSMITTING AND WIRELESSLY POWERED SENSORS FOR CHAMBER HEATING SYSTEMS

(71) Applicant: Integrated Medical Technologies, Inc., Bloomington, IL (US)

(72) Inventors: William Bryan Smith, Bloomington, IL (US); Michael H. Linse, Corvallis, OR (US); Nelson S. Slavik, Niles, MI (US); Gary Jay Oliver, Corvallis, OR (US)

(21) Appl. No.: 19/274,561

(22) Filed: Jul. 19, 2025

Related U.S. Application Data
(60) Provisional application No. 63/673,379, filed on Jul. 19, 2024.

(51) Int. Cl. F27D 19/00; F27D 21/00; G01K 1/022; G01K 1/024; H01Q 1/24; H01Q 1/36; H02J 50/00; H02J 50/10; H04L 27/12

(52) U.S. Cl. CPC F27D 19/00; F27D 21/0014; G01K 1/022; G01K 1/024; H01Q 1/248; H01Q 1/36; H04L 27/127; F27D 2019/0018; H02J 50/001; H02J 50/10

(57) ABSTRACT

Methods and systems implement wireless, batteryless sensors which electronically store measurements to a data logger, the data logger being configurable to compute measurements based on the frequency measurements and electronically feed back to electronic controllers of systems and apparatuses which computationally monitor temperature. A data logger can be configured to write and transmit temperature measurements to any electronic controller having a data communication interface. The temperature sensors, in conjunction with the data logger, can provide any heating system, including chamber heating systems such as dry-heat and steam sterilizers, with article-localized temperature measurement feedback, to improve the accuracy of real-time temperature monitoring and/or control. Electronic controllers can be configured to output sufficient heat, then terminate a heat control cycle or a steam sterilization cycle, after having exposed to heat some number of articles to a desired extent as specified by a cumulative heating specification or a target temperature-over-time profile.

### CROSS-REFERENCE TO RELATED APPLICATION

This application claims priority to U.S. Patent Application No. 63/673,379, entitled “WIRELESSLY TRANSMITTING AND WIRELESSLY POWERED SENSORS FOR CHAMBER HEATING SYSTEMS,” filed Jul. 19, 2024, which is expressly incorporated herein by reference in its entirety.

### BACKGROUND

Various electrical systems are configured to electrically power heating elements in an enclosed space, and are furthermore configured to electronically measure temperature in the enclosed space. Chamber heating systems include sterilizers, ovens (which can be configured for cooking, curing, manufacturing, and other such purposes), drying chambers, humidity chambers, pressure chambers, heat treatment chambers, autoclaves, and the like.

However, not all chamber heating systems are configured to achieve high accuracy of temperature monitoring. For example, thermostats of consumer ovens are configured to power a heating element until the thermostat detects a target temperature being reached. Such thermostats are not configured for precise temperature monitoring, since they are merely configured to either provide power to a heating element or to cut power to a heating element, and it is common to require users to preheat ovens to compensate for slow warmup times. As a result, consumer ovens only provide coarse temperature control even after chamber temperatures have reached a target temperature, resulting in overshooting a target temperature.

Steam and dry-heat sterilizers operate by thermal destruction of microorganisms, according to a function of time and temperature in which lower temperature requires longer time to kill specified microorganisms: they function by heating air within a chamber (for dry-heat sterilizers), or by replacing the air with pressurized saturated steam (for steam sterilizers). Greater uniformity of temperature may be needed over other chamber heating systems, and mixing of a controlled atmosphere within the sterilization chamber may be required to minimize hot and cold areas. Temperature disparities within a steam or dry-heat sterilizer resulting from inner dimensions, as well as objects within the chamber, can limit precision of temperature monitoring.

Regardless of whether a chamber heating system is used for such precision applications or not, there is a need to provide chamber heating systems with temperature measurements to improve performance of electronic temperature monitoring and/or control in achieving expected outcomes.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1A illustrates a high-heat wirelessly transmitting temperature sensor according to example embodiments of the present disclosure.

FIG. 1B illustrates a data logger according to example embodiments of the present disclosure.

FIG. 2 illustrates an example of relationship of a characteristic frequency of an inductor core of an oscillator on temperature, according to example embodiments of the present disclosure.

FIG. 3A illustrates a perspective view of a high-heat wirelessly transmitting temperature sensor according to example embodiments of the present disclosure situated within a chamber of a chamber heating system which is configured to provide one or more RF sources.

FIG. 3B illustrates a spectrum analyzer including a carrier signal receiver according to example embodiments of the present disclosure.

FIG. 3C illustrates a diagram of data transmission from the high-heat wirelessly transmitting temperature sensor of FIG. 1A to the data logger of FIG. 1B to the spectrum analyzer of FIG. 3B.

FIG. 4 illustrates target article-localized temperature over three control phases of an electronic controller configured to operate a dry-heat chamber heating system from a cold start.

FIG. 5 illustrates a chamber heating monitoring system according to example embodiments of the present disclosure.

FIG. 6A illustrates a display interface displaying a cumulative number of article-localized log-kills according to example embodiments of the present disclosure.

FIG. 6B illustrates a display interface displaying a cumulative number of article-localized log-kills periodically refreshed for comparison to a threshold of log-kills according to example embodiments of the present disclosure.

FIGS. 6C and 6D illustrate a graphical trending illustration of a cumulative number of article-localized log-kills over time according to example embodiments of the present disclosure.

FIG. 7 illustrates an example system for implementing the processes and methods described herein for implementing temperature monitoring.

### DETAILED DESCRIPTION

Apparatuses and methods discussed herein are directed to implementing sensors, and more specifically wireless, batteryless sensors which electronically store measurements to a data logger, the data logger being configurable to compute measurements based on the frequency measurements and electronically feed back to electronic controllers of systems and apparatuses which computationally monitor temperature and control temperature by powering heating elements.

Subsequently such electrical systems which heat an enclosed space are referred to as “chamber heating systems,” for brevity.

Each of these chamber heating systems includes at least a heating element electrically connected to a power source, and an electronic controller electrically connected to a power source of the heating element. The chamber heating system can be configured to power the heating element from the power source, causing (in the case of, for example, dry-heat sterilizers or ovens) the heating element to dissipate heat into an enclosed chamber of the chamber heating system, or causing (in the case of, for example, steam sterilizers) heating of a water supply to saturated steam condition which is pumped into an enclosed chamber of the chamber heating system to a specified pressure.

Sterilizers, including dry-heat sterilizers, steam sterilizers, and the like, include both freestanding and tabletop machines which are operated in or near a staffed working facility, such as a laboratory, a medical clinic, a hospital, a physician or dental practice, a beauty or nail salon, and such occupational locations where various equipment, instruments, and the like (subsequently “articles,” for brevity) routinely become contaminated with microorganisms and should not be used again until returned to sterile conditions (such facilities subsequently referred to as “sterilization practicing facilities,” for brevity). For example, in a dental clinic, medical practitioners wish to sterilize dental instruments which enter a patient's mouth, such as periodontal probes, explorers, forceps, curettes, scalers, mouth mirrors, and the like, after every use. In the United States, sterilization of articles in such working facilities is motivated by workplace safety and public health laws. Even in the absence of such laws, however, sterilization of articles is motivated by the desire to avoid introducing health hazards into the sterilization practicing facility, which would ultimately result from using unsterilized articles.

Ovens include both freestanding and tabletop machines which are operated in kitchens and food manufacturing and processing facilities; factories and industrial manufacturing and testing facilities; laboratories; and such residential or occupational locations where raw or processed materials need to be cooked, cured (whether in the sense of food preservation, polymeric material treatment, vulcanization, and the like), dried, or otherwise exposed to heat.

For the sake of safe handling of contaminated articles before sterilization, and maintaining sterilization of articles until they are ready for use, users of contaminated articles commonly clean and package the contaminated articles before sterilization, and do not remove the packaging after sterilization, so that the packaged articles can be stored in a sterilized state until used again. Used, contaminated articles can be packaged in bags, wrappings, films, or other such protective covers which enclose and protect the articles against outside air, environmental contamination, and direct contact. Users of contaminated articles can also use marked, labeled packaging to enclose contaminated articles, so as to provide visual indication that the articles are either contaminated or have passed through a sterilization process. Moreover, users of contaminated articles can also use packaging to safely handle articles which are edged or pointed.

In different chamber heating systems, heating elements can be configured differently relative to an enclosed chamber. Heating elements can be inside a chamber, adjacent to a chamber, above or below a chamber, wrapped around a chamber, set apart from a chamber by ducts or insulation, and the like. In steam sterilizers, heating elements can likewise be inside a chamber or outside a chamber, situated depending on location of a steam source. As a result, local temperatures at a heating element can vary be different from local temperatures within the chamber. Furthermore, the time required for heat dissipated from a heating element, or saturated steam pumped into the chamber, to heat objects in the chamber can also vary.

Moreover, in sterilizers, as well as other chamber heating systems such as composite curing and drying ovens, environmental conditions wherein contaminated articles are subject to exceptionally high temperatures may be required to kill microorganisms on contaminated articles, or exceptionally high temperatures may otherwise be required to operate the chamber heating system for its intended purpose. For example, high velocity hot air sterilizers are configured to operate at approximately 320° F. to 375° F. or higher. Such units perform dry-heat sterilization by reaching the highest temperature compatible with heat-tolerant medical and dental instruments in a short time. Furthermore, steam sterilizers are configured to operate at 250° F. to 275° F. or higher, and may be configured to perform steam sterilization cycles where such temperatures are sustained for 2-3 minutes or more, such as 5 minutes.

Furthermore, at yet higher temperatures, conveyor impinger ovens in the food processing industry are configured to operate at 600° F. or higher, and powder coating ovens are configured to operate at 1400° F. or higher.

To measure temperatures in high-temperature chamber heating systems, thermocouple probes can be installed in an enclosed chamber of the system. Thermocouple probes include sheathed temperature sensors connected to an electronic thermostat by sheathed electrical wires. The sensor can be physically situated in or adjacent to the chamber, or can be adjacent to a heating element, and the like, and can be electronically wired to a thermostat outside the chamber. However, such thermocouple probes are rigid apparatuses and are not flexible, and are limited in precise positioning, within an enclosed chamber.

Thermocouple probes also include probes constructed from wire, which can be smaller in form than rigid probes. However, the packaging of contaminated articles in sterilizers can also hinder the localization of temperature measurements, as thermocouple probes, whether rigid probes or wire-constructed probes, cannot pass through packaging. Furthermore, the installation of multiple thermocouple probes in a chamber heating system is substantially onerous in installation, wiring, and labor. Consequently, thermocouple probes cannot localize temperature measurements to contaminated articles in an enclosed chamber, and can only measure surrounding temperatures, thereby negatively impacting accuracy of temperature monitoring.

Thus, sterilizers in common industrial and commercial usage cannot measure data to indicate that microorganisms have been killed. As a result, sterilization practicing facilities must indirectly validate the function of sterilizers by observing sterilizers during operation and by inspecting articles removed from the sterilizers after operation.

For example, sterilization validation can utilize test strips formulated to change color in the presence of particular molecules, pH values, or microbes, which can be packaged alongside contaminated articles in a sterilizer, so as to provide visual indicators of molecules, pH values, and the like. Such visual indicators can be translated to concentrations of particular chemicals. However, such test strips can only be manually inspected while a heating system is not operating, and may require hours or days to be quantitatively evaluated, and therefore cannot provide real-time indications of sterile conditions. Furthermore, such test strips do not provide any input for electronic controllers.

Sterilization validation can also utilize a biological challenge in which a small package of hard-to-kill bacterial spores is included with the load of items to be sterilized. Sterilizer operation is validated if post-process culture of the challenge organisms finds no growth. Validation by biological challenges, however, has the same limitations as test strip validation as described above.

Moreover, other chamber heating systems are configured to establish a closed-loop control system to achieve greater accuracy of temperature control. In a closed-loop control system, temperature can be controlled by a proportional-integral-derivative (“PID”) controller computing PID terms based on powering a heating element to adjust temperature in a chamber heating system, receiving temperature measurements from the chamber heating system as real-time feedback, computing PID terms based on the real-time feedback, and adjusting power to the heating element based on the PID terms.

The PID controller determines a real-time temperature measurement in the chamber, compares the temperature measurement to a setpoint of a feedback loop, computes PID terms based on the comparison, and adjusts power to the heating element based on the PID terms.

Computation of PID terms by the PID controller is configured to control temperature in the chamber heating system by adjusting power to the heating element to minimize or eliminate differences between the temperature measurement and the setpoint. However, effectiveness of the PID controller's temperature control depends on the accuracy of the temperature measurements. Temperature measurements should be captured in real time so that the PID term computations are not based on outdated data. Furthermore, since most chamber heating systems do not distribute heat perfectly evenly, temperature measurements should be captured proximate to objects being heated in the chamber heating system.

Therefore, example embodiments of the present disclosure provide temperature sensors which wirelessly and electronically store frequency measurements to a data logger, the data logger being configurable to compute temperature conversions based on the frequency measurements and electronically transmit temperature conversions as real-time feedback to electronic temperature controllers. By the temperature sensors relaying frequency measurements to a data logger, the data logger can be configured to write and transmit temperature conversions to any electronic controller having a data communication interface. The temperature sensors, in conjunction with the data logger, can provide any heating system, including chamber heating systems, with article-localized temperature feedback, to improve the accuracy of real-time temperature monitoring and/or control.

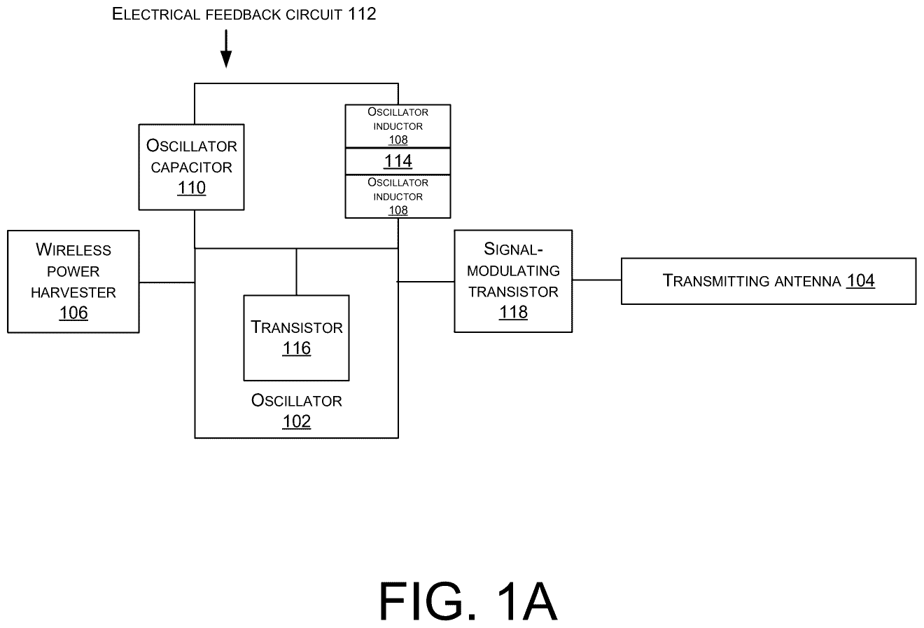

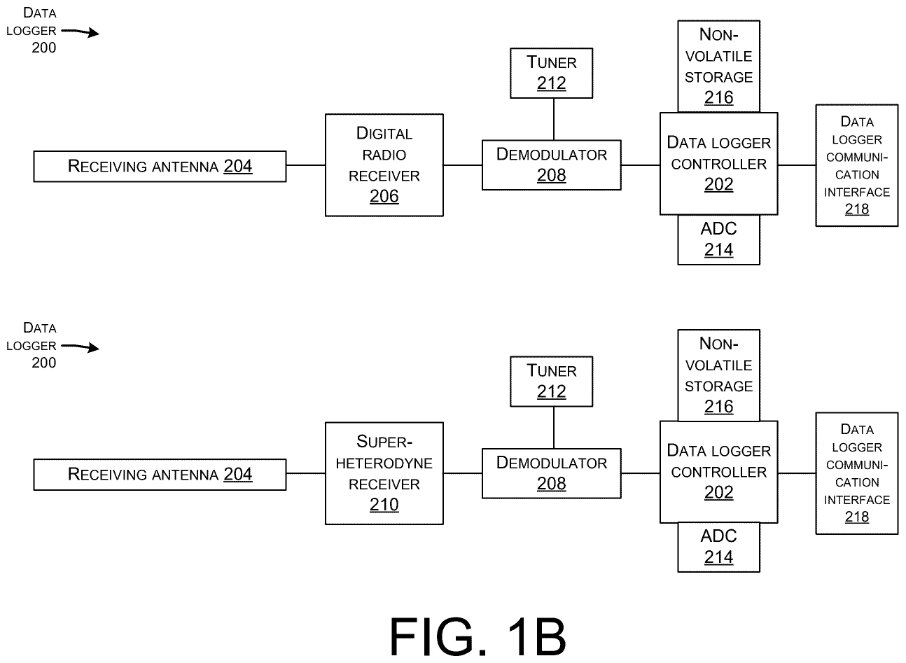

FIG. 1A illustrates a high-heat wirelessly transmitting temperature sensor 100 according to example embodiments of the present disclosure. The high-heat wirelessly transmitting temperature sensor 100 includes at least an oscillator 102, a transmitting antenna 104, and a wireless power harvester 106.

It should be understood that, according to example embodiments of the present disclosure, a “high-heat” wirelessly transmitting temperature sensor 100 is operative to transmit an electric current from the oscillator 102 to the transmitting antenna 104, and to emit an electromagnetic wave from the antenna, at temperatures up to approximately 300 to 400 degrees Fahrenheit, and up to approximately 150 to 250 degrees Celsius (subsequently referred to as a “high-heat operating temperature range,” for brevity). It is not necessary for the high-heat wirelessly transmitting temperature sensor 100 to include heat insulation in order to achieve such high-heat operability. It is also not necessary for the high-heat wirelessly transmitting temperature sensor 100 to include phase-change materials (“PCMs”) to absorb heat in order to achieve such high-heat operability.

It should be understood that, according to example embodiments of the present disclosure, a transmitting antenna 104 is not limited to transmitting electromagnetic signals, and can furthermore receive electromagnetic signals.

According to example embodiments of the present disclosure, the high-heat wirelessly transmitting temperature sensor 100 is configured to transmit signals to electronic controllers of chamber heating systems as described subsequently. To transmit these signals, the high-heat wirelessly transmitting temperature sensor 100 does not need to be connected to any power sources by electrical wiring, does not need to be connected to any input/output pin by any electrical circuit, and does not need to be connected to any communication interfaces by any data bus.

By way of example, an oscillator 102 can be an electronic oscillator, which is driven by the wireless power harvester 106 to generate an oscillating electric signal. The oscillator 102 is further configured such that its frequency of oscillation varies dependent upon temperature, over at least a range of temperatures up to approximately 120 to 300 degrees Celsius. Not all electronic oscillators have such characteristics. Subsequently, example embodiments of the present disclosure in accordance with the above-mentioned characteristics are described.

An oscillator 102 according to example embodiments of the present disclosure can be an LC oscillator circuit, which includes a first passive electronic component 108 and a second passive electronic component 110 connected in an electrical feedback circuit 112. The first passive electronic component 108 is a two-terminal electronic component having higher inductance than either resistance or capacitance. The second passive electronic component 110 is a two-terminal electronic component having higher capacitance than either resistance or inductance. The first passive electronic component 108 and the second passive electronic component 110 are configured to transfer an electric current from the first passive electronic component 108 to the second passive electronic component 110, and vice versa, through the electrical feedback circuit 112, yielding an oscillating electric signal. The first passive electronic component 108 can be an iron core inductor, which further includes an inductor core 114 composed of a ferromagnetic material.

By way of example, inductor cores 114 can be composed of an iron powder material such as ferrite. Magnetic cores of various materials are characterized by their respective Curie temperatures, where the core is ferromagnetic below the Curie temperature, but, above the Curie temperature, is no longer paramagnetic.

According to example embodiments of the present disclosure, an inductor core material has a Curie temperature substantially above 400 degrees Fahrenheit or 200 degrees Celsius, so that performance of the LC oscillator circuit is not impacted by loss of ferromagnetic properties at upper bounds of a high-heat operating temperature range. By way of example, ferrite cores of various compositions, such as the “type 52” composition, and the “type 61” composition, are offered by various manufacturers. Type 52 ferrite has a Curie temperature of approximately 285 degrees Celsius, and Type 61 ferrite has a Curie temperature of approximately 380 degrees Celsius, both being substantially above a high-heat operating temperature range.

An oscillator 102 can further include one or more transistors 116. A transistor 116 is a semiconductor configured in an LC oscillator circuit to convert a direct current (“DC”) electric current from a wireless power harvester 106 to an alternating current (“AC”) electric current, and to amplify the converted AC electric current flowing into the feedback circuit.

It should be understood that not all transistors are operable at a high-heat operating temperature range according to example embodiments of the present disclosure. A transistor is a power semiconductor device, and a variety of such devices suffer from leakage currents above 100 degrees Celsius, thus rendering them unsuitable to amplify electric currents as required. Transistors which are operable at a high-heat operating temperature range include, but are not limited to, bipolar junction transistors (“BJTs”) and some varieties of field-effect transistors (“FETs”).

An electrical signal carried by the LC oscillator circuit converges, over time, to an equilibrium of approximately regular oscillation above and below an oscillation frequency. It should be understood that an oscillation frequency of an oscillator 102 is dependent upon at least a material of a core of an first passive electronic component 108 of the oscillator 102 (and, furthermore, each respective material can naturally damp the oscillation to some extent); herein, the oscillation frequency at equilibrium of an inductor core of any particular material is referred to as its respective “characteristic frequency.” Furthermore, an oscillation envelope of an oscillator 102 is also dependent upon at least a material of the core of the first passive electronic component 108.

Furthermore, according to example embodiments of the present disclosure, an inductor core 114 of an oscillator 102 is composed of a material having a temperature-dependent characteristic frequency. The temperature dependency of the characteristic frequency of the inductor core should be sufficiently granular such that a temperature difference of approximately one degree Celsius, at any temperature across substantially all of a high-heat operating temperature range, is resolvable by a difference in characteristic frequency having an order of magnitude of 10 hertz or more. Thus, according to example embodiments of the present disclosure, frequency measurement noise which occurs at a sub-10 hertz order of magnitude can be negligible to the accuracy of a high-heat wirelessly transmitting temperature sensor 100. A temperature dependency of 1000 Hz/C, in a linear sensor, can be sufficiently granular such that a temperature difference of approximately 0.001 Celsius, at any temperature across substantially all of a high-heat operating temperature range, is resolvable by a difference in characteristic frequency having an order of magnitude of 1 hertz or more.

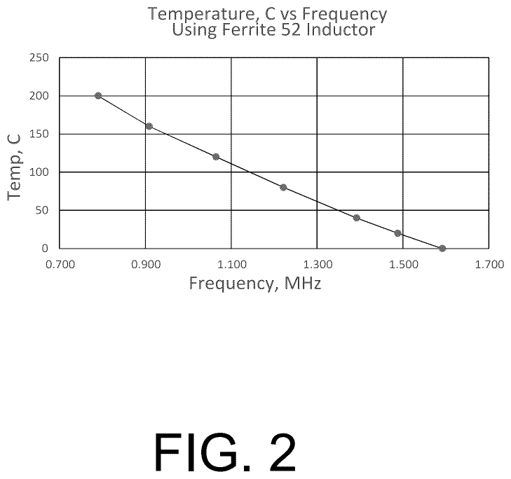

FIG. 2 illustrates an example of relationship of a characteristic frequency of an inductor core 114 of an oscillator 102 to temperature (a “temperature-frequency relationship”), according to example embodiments of the present disclosure. The properties illustrated in FIG. 2 correspond to an inductor core of type 52 ferrite, in particular. It can be seen that, for type 52 ferrite, characteristic frequency decreases as temperature increases. Although this relationship is non-linear, characteristic frequency decreases by an average of approximately 4.2 MHz for every increase by one degree Celsius.

Furthermore, other electronic components of the oscillator 102, such as the first passive electronic component 108, the second passive electronic component 110, resistors (not illustrated, but being two-terminal passive electronic components having higher resistance than either inductance or capacitance) in an electrical feedback circuit 112, and the like should be understood to also oscillate at certain frequencies, which can be also temperature-dependent; the components of the oscillator 102 can therefore collectively contribute to an aggregate oscillation frequency of the oscillator 102 as a whole. According to some example embodiments of the present disclosure, temperature-dependent frequency differences of other components of an oscillator 102 are negligible compared to temperature-dependent frequency differences of an inductor core 114, and the inductor core 114 contributes a dominant component of the aggregate oscillation frequency. According to other example embodiments of the present disclosure, no component of the oscillator 102 contributes a dominant component of the aggregate oscillation frequency.

The electrical feedback circuit of the oscillator 102 is in electrical connection to the transmitting antenna 104, and the transmitting antenna 104 is configured to transmit the oscillating electric signal carried by the electrical feedback circuit 112 as a radio carrier signal.

According to further example embodiments of the present disclosure, the oscillator 102 can, optionally, further include one or more signal-modulating transistors 118. A signal-modulating transistor 118 modulates the radio carrier signal, and a modulated radio carrier signal generated in this fashion is transmitted by the transmitting antenna 104. Herein, calibration by the data logger controller 202 is performed for temperature-responsive circuit elements of a signal-modulating transistor 118; while the oscillator 102 still generates the oscillating electric signal which is transmitted as a radio carrier signal, the oscillator 102 operates at substantially constant frequency.

Such an LC oscillator circuit might not include a ferrite inductor core, so as to minimize temperature-dependency of its characteristic frequency, and can instead include a coreless inductor (as described subsequently) to provide stable oscillation frequency over a high-heat operating temperature range. Instead, the oscillator 102 is implemented as a resonator having a temperature-dependent characteristic frequency.

A resonator according to example embodiments of the present disclosure can be a quartz crystal resonator implemented to provide comparatively stable carrier frequency in the modulated-oscillator sensor configuration. By way of example, Statek Corporation provides quartz temperature sensor crystal resonators. having temperature coefficients of roughly 50 ppm/C, for working frequencies of roughly 200 KHz, or roughly 10 Hz/C.

Alternatively, a resonator according to example embodiments of the present disclosure can be a microelectromechanical system (“MEMS”) resonator implemented by fashions similar to IC fabrication methods, having mechanical movement and temperature response.

The radio carrier signal is received by a receiving antenna which is in electrical connection to a controller of a data logger 200, which shall be described subsequently and with reference to FIG. 1B.

The data logger controller 202 is configured to convert radio carrier signals of different frequencies to corresponding temperature values, based on a temperature-frequency relationship of an inductor core of the oscillator 102. In other words, the data logger controller 202 is configured based on a temperature-frequency relationship which maps a range of frequencies to multiple temperature values. Moreover, due to the above-described frequency measurement noise which can occur at a sub-10 hertz order of magnitude, the data logger controller 202 can be configured based on the temperature-frequency relationship to map distinct oscillation frequencies of the oscillator 102 across a range of frequencies to different temperature values across a range of temperatures, where each of the distinct oscillation frequencies are separated by an order of magnitude of 10 hertz or more.

A signal-modulating transistor 118 can be configured to modulate various features of a radio carrier signal, such as by performing amplitude modulation, phase modulation, frequency modulation, and the like upon a radio carrier signal.

To map oscillation frequencies of the oscillator 102 to temperature values, the data logger controller 202 can be configured to operate in a calibration mode, wherein the data logger controller 202 periodically receives a radio carrier signal from a high-heat wirelessly transmitting temperature sensor 100 while it is within an operating chamber heating system, proximate to an integral temperature sensor of the chamber heating system. Temperature measurements of the integral temperature sensors can be relayed to the data logger controller 202 manually, by a data communication interface, by a data bus, a wired or wireless network connection, and the like. By comparing the respective frequencies of radio carrier signals to temperature measurements of the integral temperature sensors, the data logger controller 202 is configured to generate a mapping of oscillation frequencies to temperature values.

Furthermore, example embodiments of the present disclosure provide multiple high-heat wirelessly transmitting temperature sensors 100, wherein an oscillator 102 of each includes a differently-configured signal-modulating transistor 118. Differently-configured signal-modulating transistors 118 are each configured to modulate a feature of respective radio carrier signals differently. By way of example, differently-configured signal-modulating transistors 118 can be configured to modulate amplitudes of respective radio carrier signals within mutually exclusive ranges of amplitudes. Alternatively, differently-configured signal-modulating transistors 118 can be configured to modulate phase of respective radio carrier signals within mutually exclusive phase shifts. Alternatively, differently-configured signal-modulating transistors 118 can be configured to modulate frequencies of respective radio carrier signals within mutually exclusive ranges of frequencies.

Alternatively, the oscillator can include one or more resistance temperature sensors, such as platinum resistance sensors, thermistors, and the like. A resistance temperature sensor can likewise modulate various features of a radio carrier signal, such as by performing amplitude modulation, phase modulation, frequency modulation, and the like upon a radio carrier signal, within mutually exclusive ranges of amplitudes, mutually exclusive phase shifts, mutually exclusive ranges of frequencies, and the like.

Consequently, given multiple high-heat wirelessly transmitting temperature sensors 100, each sensor is configured to transmit a differently-modulated radio carrier signal. Each sensor is configured to transmit, relative to each other sensor, differently-modulated radio carrier signals occupying mutually exclusive ranges of frequencies; mutually exclusive ranges of amplitudes; and/or mutually exclusive phase shifts. Therefore, the sensors are collectively configured so that, even in the event that respective oscillators 102 of the two sensors oscillate at a substantially same oscillation frequency, no two sensors transmit respective radio carrier signals which substantially overlap in waveform.

By way of further example, an oscillator 102 can be a crystal oscillator, which can be in electrical connection to the transmitting antenna 104 in a similar fashion as described above. It should be understood that crystal oscillators as described herein should have a temperature-dependent oscillation frequency profile over a high-heat operating temperature range. Furthermore, given multiple high-heat wirelessly transmitting temperature sensors 100, each sensor can include a piezoelectric crystal cut differently to oscillate at a mutually exclusive range of temperature-dependent frequencies.

Moreover, as crystal oscillators can be calibrated using external crystals as references, the accuracy of an oscillator 102 utilizing a piezoelectric crystal can be readily verified prior to operation. Therefore, the use of crystal oscillators in implementing example embodiments of the present disclosure can be beneficial in the event that the chamber heating system is subject to strict regulatory standards for verifying operational accuracy.

By way of further example, an oscillator 102 can be a mechanical oscillator.

According to example embodiments of the present disclosure, the wireless power harvester 106 can include a power harvesting antenna 120, or rectenna, which includes a dipole receiving antenna 122 configured to receive a radio frequency (“RF”) signal from an RF source, which induces an alternating current in the receiving antenna 122. By way of example, the receiving antenna 122 can include one or more low-profile or planar antennas, such as a patch antenna or an array of patch antennas, or otherwise any kind of microstrip antenna. However, it should be understood that the receiving antenna 122 does not need to be planar in profile.

By way of example, the receiving antenna 122 can include a coreless inductor 124 configured to passively store electric energy in an electromagnetic field. A coreless inductor 124 according to example embodiments of the present disclosure does not include a ferromagnetic core as described above, and includes a planar spiral coiled wire configured to carry an alternating current. Coils of the planar spiral coiled wire can be circular, square, hexagonal, or otherwise any other concentric coiled shape. By way of example, a coreless inductor can be an integrated circuit printed on a substrate.

The power harvesting antenna 120, or rectenna, can further include a rectifier 126 in electrical connection with the receiving antenna 122. The rectifier 126 can be an RF diode configured to rectify an alternating current carried by the receiving antenna 122, outputting a direct current. The oscillator 102 is connected across the rectifier 126 in an electrical current as a load, such that the direct current powers the oscillator 102.

The power harvesting antenna 120 can be the same antenna as the transmitting antenna 104 as described above, or can be a separate antenna.

Optionally, the wireless power harvester 106 can further include an impedance matching network circuit 128 in electrical connection with the power harvesting antenna 120, configured to match impedance of the RF source and the oscillator 102, thereby improving power transfer efficiency from the RF source to the oscillator 102.

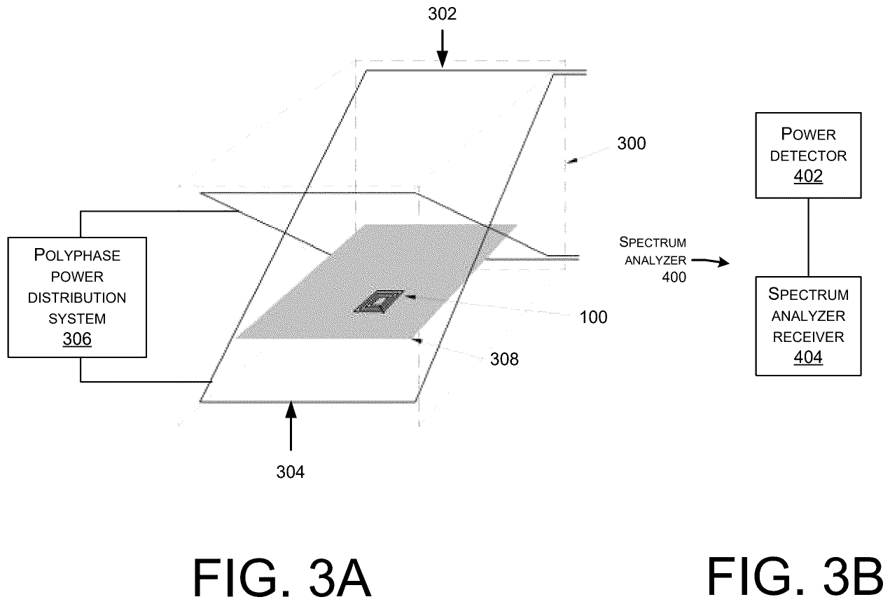

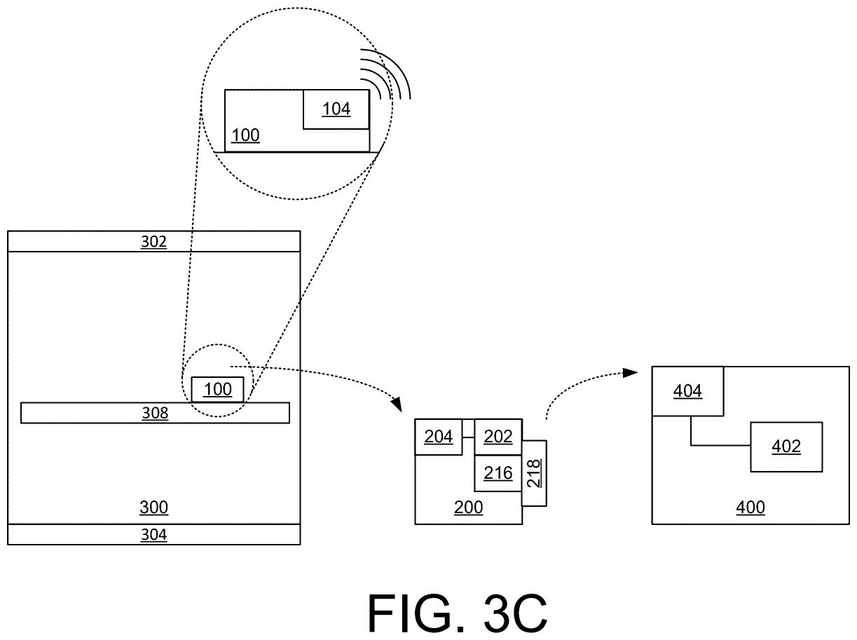

According to example embodiments of the present disclosure, the wireless power harvester 106 is configured to receive an RF signal from an RF source outside of the high-heat wirelessly transmitting temperature sensor 100. FIG. 3A illustrates a perspective view of a high-heat wirelessly transmitting temperature sensor 100 according to example embodiments of the present disclosure situated within a chamber of a chamber heating system which is configured to provide one or more RF sources.

The chamber 300 of a chamber heating system (the rest of the chamber heating system not being illustrated herein) is enclosed within one or more radiofrequency coils (“RF coils”). By way of example, a first RF coil 302 and a second RF coil 304 each encloses a perimeter of the chamber 300.

Each RF coil is a magnetic field coil which is polarized such that, while carrying an electric current, the magnetic field coil generates a magnetic field having a polarization direction. According to example embodiments of the present disclosure, current can be passed through multiple RF coils powered by a polyphase power distribution system 306. A polyphase power distribution system 306 is configured to deliver multiple alternating currents through multiple electrical conductors, where each alternating current is phase-offset from each other alternating current. Furthermore, the rectifier 126 as described above can be a polyphase rectifier, providing an electrical circuit which combines the phase-offset alternating currents and outputs one direct current to power the oscillator 102. The implementation of an RF source as multiple RF coils powered by a polyphase power distribution system 306, and the implementation of a rectifier 126 as a polyphase rectifier, can improve power transfer efficiency from the RF source to the oscillator 102.

The chamber 300 further includes at least one rest member 308, which can be integral to the chamber, detachably mountable within the chamber 300, or removably placed within the chamber 300. The rest member 308 can be composed of any material which is refractory at temperatures of a high-heat operating temperature range as described above. The rest member 308 can have any structure including a substantially level surface whereupon one or more high-heat wirelessly transmitting temperature sensors 100 can rest in place. According to example embodiments of the present disclosure where a chamber heating system is a sterilizer, the rest member 308 can have any structure having a substantially level surface whereupon packaged articles as described above can rest in place.

According to example embodiments of the present disclosure, each RF coil enclosing a chamber 300 is oriented such that they generate respective magnetic fields having differently oriented polarization directions. Furthermore, these RF coils are oriented such that none of them generate respective magnetic fields substantially orthogonal in polarization direction to a substantially level surface of a rest member 308. By way of example, as illustrated in FIG. 3, both RF coil 302 and RF coil 304 are differently angled such that they generate respective magnetic fields having polarization directions different from each other, neither polarization direction being orthogonal to a surface of rest member 308.

Furthermore, according to example embodiments of the present disclosure, at least one wall of the chamber 300 provides a door (not illustrated herein) permitting access to the interior of the chamber. Each RF coil enclosing the chamber 300 is oriented such that it does not intersect the opening of one or more doors of the chamber 300.

Otherwise, according to example embodiments of the present disclosure, there shall be no limitations as to how a chamber heating system is implemented. A chamber heating system can be a steam sterilizer or dry-heat sterilizer, a consumer cooking oven or a commercial curing or drying oven, a drying chamber, a humidity chamber, a pressure chamber, a heat treatment chamber, an autoclave, and the like. A chamber heating system can receive articles to be heated, which can include contaminated, non-sterile articles, and can furthermore receive one or more high-heat wirelessly transmitting temperature sensors 100, through a door of the chamber 300 as mentioned above.

The articles can furthermore be packaged using heat-permeable packaging, in which case a high-heat wirelessly transmitting temperature sensor 100 can be placed within the packaging. A rest member 308 configured to receive articles, including packaged articles, can be, by way of example, a perforated tray coupled within a chamber by tray rails.

The chamber 300 can be enclosed within an outer chamber configured to pass heat to the chamber 300; by way of example, the chamber 300 can be a sterilization chamber enclosed within the heating chamber. Such chambers can furthermore be encompassed within an insulating cavity configured to minimize heat loss from the chamber 300 during operation, and to provide a heat barrier between the chamber 300 and outer housings of the chamber heating system.

A chamber heating system can be configured to heat air by one or more powered heating elements, and propel heated air to flow through ducted assemblies forming any number of pathways through the heating chamber adjacent to any number of sides of the chamber 300. A chamber heating system can alternatively be configured to heat water to saturation by one or more powered heating elements, and propel saturated steam to flow into the chamber 300. Such pathways can enter and exit through walls of the chamber 300 through at least one entrance portal and at least one exhaust portal.

A chamber heating system can include an electronic controller configured to send control signals to increase or decrease power draw to heating elements and to mechanical ventilation assemblies such as circulation fans which propel heated air, or pumps which drive saturated steam. Ventilation assemblies can be configured to impose positive pressure and air velocity to propel heated air or drive saturated steam in various directions. Various chamber heating systems can situate heating elements and ventilation assemblies within the chamber 300, or outside the chamber 300 and within a heating chamber, or outside the chamber 300 and at a steam supply.

A heating element can include a wire manufactured from any heat-conducting metal, and can be mounted in various configurations within a chamber heating system by one or more electrical insulators.

Thus, according to any example embodiments of the present disclosure, one or more ventilation assemblies propel heated air from one or more heating assemblies, or propel saturated steam from a steam source, into and/or within a chamber 300, wherein one or more high-heat wirelessly transmitting temperature sensors 100 may be positioned anywhere within the chamber 300, including within packaging of packaged articles, during operation of the chamber heating system. It should be understood that each temperature sensor can be placed, at least, arbitrarily close in proximity of one or more articles to be heated in the chamber 300, so that each respective temperature sensor is exposed to substantially the same temperature as those articles during operation of the chamber heating system.

In addition to sending control signals to heating elements and to ventilation assemblies, the chamber heating system can be configured to send control signals to one or more RF sources enclosing the chamber 300, such as RF coils as described above, where control signals can power the RF coils with alternating currents during operation of the chamber heating system. The one or more high-heat wirelessly transmitting temperature sensors 100 are each powered by a rectifier converting received RF signals at a power harvesting antenna to a direct current, as described above. Thereby, during operation of the chamber heating system, each high-heat wirelessly transmitting temperature sensor 100 is powered to drive an oscillator 102 to oscillate at an oscillation frequency, and, in turn, to drive a transmitting antenna 104 to transmit an oscillating electric signal as a radio carrier signal or as a modulated radio carrier signal.

Each radio carrier signal can be received by a receiving antenna 204 which is in electrical connection, by interconnections to other electronic components, to a data logger controller 202. A receiving antenna 204 can be electronically coupled to a microprocessor configured as a digital radio receiver 206, which is configured to receive a modulated radio carrier signal and transmit the radio carrier signal to a demodulator 208. Alternatively, a receiving antenna 204 can be electronically coupled to a superheterodyne receiver 210, which is configured to convert a modulated radio carrier signal to an intermediate frequency, and transmit the intermediate frequency radio carrier signal to a demodulator 208. A superheterodyne receiver 210 can be single-conversion, double-conversion, triple-conversion, and the like.

The demodulator 208 is further configured to demodulate the modulated radio carrier signal by removing one of several different radio frequencies. A tuner 212 can be electronically configured with multiple different radio frequencies, and the demodulator 208 is, in accordance, configured to operate across each of the multiple different radio frequencies. Each of the multiple different radio frequencies corresponds to a range of frequencies occupied by a differently-modulated radio carrier signal as described above.

The multiple different radio frequencies can be specified by pre-configured integrated circuits of the demodulator 208, or can be specified by one or more pre-configured sets of computer-executable instructions run by the digital radio receiver 206. Alternatively, the integrated circuits or the computer-executable instructions need not be pre-configured, and can, respectively, be dynamically configured by a spectrum analyzer 400 including a carrier signal receiver 404 as described subsequently and with reference to FIG. 3B.

A spectrum analyzer 400 according to example embodiments of the present disclosure can include a power detector 402 configured to measure magnitudes of RF signals over a range of analyzed frequencies. A spectrum analyzer 400 further includes components such as a carrier signal receiver 404, which is configured to receive radio carrier signal of variable frequencies; a carrier signal receiver 404 can be configured to receive different radio signal frequencies by a voltage-controlled oscillator. The carrier signal receiver 404 can be implemented as a superheterodyne receiver 210, as described above.

Furthermore, a spectrum analyzer 400 can be a swept-tuned analyzer, can be a parallel-filter analyzer, can be a fast Fourier transform analyzer, can be a vector signal analyzer, and the like. A swept-tuned analyzer can be configured to sweep a received frequency of a carrier signal receiver across a range of analyzed frequencies over time, but cannot detect all frequencies simultaneously. A parallel-filter analyzer, a fast Fourier transform analyzer, and a vector signal analyzer can each simultaneously sample each frequency across a range of analyzed frequencies. Furthermore, a fast Fourier transform analyzer and a vector signal analyzer further include an analog-to-digital converter, configured to convert a radio carrier signal to a digital signal.

According to each implementation of a spectrum analyzer 400, the range of analyzed frequencies can be limited to a pre-programmed range.

According to example embodiments of the present disclosure, given multiple sensors each configured to transmit, relative to each other sensor, differently-modulated radio carrier signals occupying mutually exclusive ranges of frequencies, it is expected that across a range of analyzed frequencies, a larger-than-average signal magnitude can arise at each of those mutually exclusive ranges of frequencies. Therefore, a spectrum analyzer 400 according to example embodiments of the present disclosure, regardless of implementation, can be configured to identify each frequency corresponding to a larger-than-average signal magnitude across the range of analyzed frequencies, and, based on each identified frequency, configure integrated circuits of a demodulator 208 or to configure computer-executable instructions run by the digital radio receiver 206. Therefore, each identified frequency can be one of the multiple different radio frequencies which the demodulator 208 is configured to remove.

FIG. 3C illustrates a diagram of data transmission from the high-heat wirelessly transmitting temperature sensor 100 of FIG. 1A to the data logger 200 of FIG. 1B to the spectrum analyzer 400 of FIG. 3B.

According to further example embodiments of the present disclosure, a digital radio receiver 206 or a superheterodyne receiver 210 can be configured to detect current flow to each of first RF coil 302 and second RF coil 304 from a polyphase power distribution system 306, and to receive a radio carrier signal based on a set timing following such a current flow. Since current flow to RF sources powers the generation of an RF signal by RF sources, a radio carrier signal received following a current flow is more likely to result from measurements generated by RF sources of the chamber 300, rather than any other errant RF sources. In this fashion, the digital radio receiver 206 is configured to minimize confounding RF signals from other sources.

According to example embodiments of the present disclosure, the data logger 200 can be configured as an electronic system integrated in electronic communication with an electronic controller of the chamber heating system, or can be a separate system. As described above, the data logger controller 202 is configured to convert oscillating radio signals demodulated from the digital radio receiver 206 or the superheterodyne receiver 210 to corresponding temperature conversions, where a conversion from an oscillating radio signal to a temperature conversion is calibrated based on a temperature-frequency relationship of an inductor core 114 of the oscillator 102. The data logger controller 202 can be configured based on the temperature-frequency relationship to map distinct oscillation frequencies of the oscillator 102 across a range of frequencies to different temperature values across a range of temperatures, where each of the distinct oscillation frequencies are separated by an order of magnitude of 10 hertz or more.

The data logger 200 can include an analog-to-digital converter 214 configured to convert an analog oscillation frequency to a digital frequency value, where the digital frequency value can be converted by a data logger controller 202 to a temperature conversion as described above.

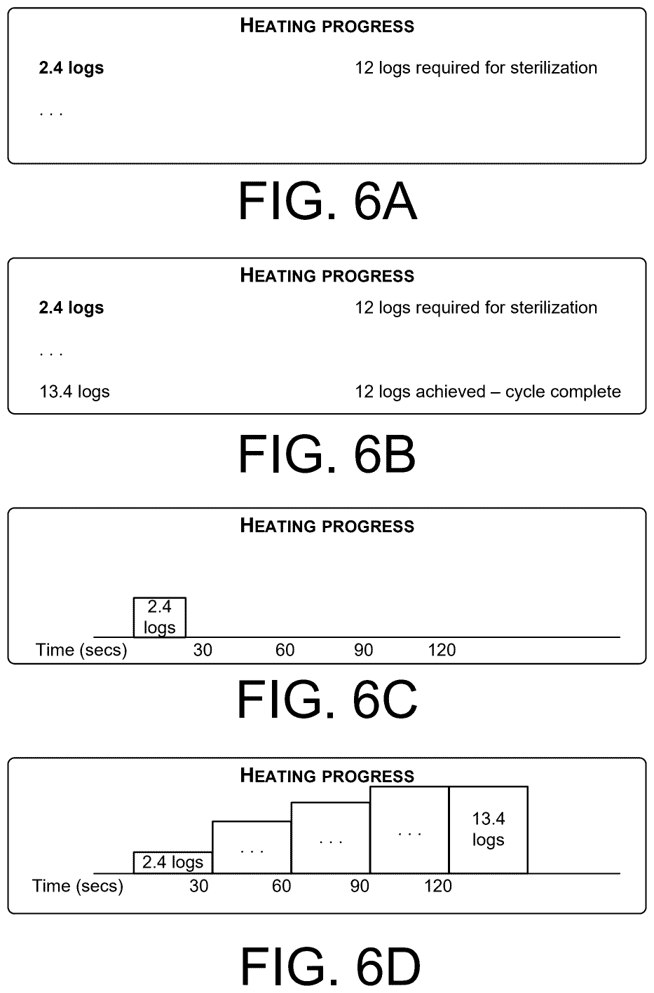

The data logger 200 can include non-volatile storage 216 configured to store oscillating radio signals demodulated from the digital radio receiver 206 or the superheterodyne receiver 210, and temperature conversions output in conversions by the data logger controller 202, as well as a timestamp corresponding to each temperature conversion, where the timestamp can correspond to one or more of: time of a current flow to one or more RF sources from a polyphase power distribution system 306, time of a digital radio receiver 206 or a superheterodyne receiver 210 receiving a modulated radio carrier signal, time of a demodulator 208 demodulating a modulated radio carrier signal, time of a data logger controller 202 converting a digital frequency value, and any other such time which distinguishes one recorded temperature conversion temporally from other temperature conversions. The non-volatile storage can include a storage medium integral to the data logger 200, and can include a removable storage medium, as described subsequently with reference to FIG. 6.

According to example embodiments of the present disclosure, the data logger controller 202 can be configured to output temperature conversions at a fine time granularity. For example, the data logger controller 202 can be configured to output approximately 15-20 temperature conversions, at an approximately regular interval, across a period of approximately 10 seconds.

The data logger controller 202 can be further configured to compute an integral of temperature conversions over a time period, based on intervals of time between consecutive timestamps within that time period. An integral of temperature conversions over a time period can be computed by multiplying each temperature conversion by a time difference between a corresponding timestamp and a consecutively earlier or consecutively later timestamp to yield a temperature-time product, then summing each temperature-time product for temperature conversions across a time period.

The data logger controller 202 can be further configured to compute an average of temperature conversions over a time period, by averaging each temperature conversion having a corresponding timestamp within a time period.

The non-volatile storage 216 can be configured to additionally store integrals of temperature conversions over a time period and/or averages of temperature conversions over a time period.

The data logger 200 further includes a data logger communication interface 218 configured to transmit temperature conversions, integrals of temperature conversions over a time period, and/or averages of temperature conversions over a time period to an electronic controller of the chamber heating system. The data logger 200 can be configured to transmit temperature conversions, integrals of temperature conversions over a time period, and/or averages of temperature conversions over a time period over the data logger communication interface 218 to any electronic controller having a data communication interface, by a data bus, a wired or wireless network connection, and the like. As the electronic controller receives temperature conversions, integrals of temperature conversions over a time period, and/or averages of temperature conversions over a time period over time, the electronic controller can use the temperature conversions, integrals of temperature conversions over a time period, and/or averages of temperature conversions over a time period as input to compute and display an article-localized heating progress on a display interface, and to send power signals to power or depower the heating elements and, according to some embodiments, the ventilation assemblies.

To compute and display an article-localized heating progress, the electronic controller of the chamber heating system can be configured to compute progress in article-localized temperatures reaching a cumulative number of log-kills or a target temperature-over-time profile, as described subsequently.

To effectively and evenly transfer heat throughout a chamber 300, the electronic controller of the chamber heating system can be configured to compute PID terms to operate a heat control cycle or a pressure control cycle to minimize deviations of article-localized temperature from target temperatures (as desired in accordance with the purpose of various chamber heating systems, such as target temperatures within a high-heat operating temperature range as described above).

A “heat control cycle” as described herein should be understood as encompassing the electronic controller of the chamber heating system powering and depowering heating elements of the chamber heating system for some number of instances over a period of time in accordance with computed PID terms to cause a temperature input to: heat to a stably sustained state or a stably oscillating state; be maintained at a stably sustained state or a stably oscillating state; and cool. A “heat control cycle” can furthermore refer to all of the above as performed over the continuous operation of a chamber heating system.

By way of example, dry-heat sterilization is based on heat conduction to achieve a temperature required to initiate bacterial spore kill in contaminated articles. Whereas sterilizers can be configured to rapidly sterilize by reaching the highest temperature compatible with contaminated articles in a short time, sterilizers can also be configured to perform dry-heat sterilization cycles (such as at temperatures between 120 and 250 degrees Celsius or higher), which include warm-up phases of rising temperature followed by periods of temperature maintenance. To implement such dry-heat sterilization cycles, article-localized temperatures are desired as inputs for PID term computations. Moreover, to improve accuracy and responsiveness of such sterilization cycles, article-localized temperatures should be measured with fine time granularity.

A “dry-heat sterilization cycle” as described herein should be understood as a heat control cycle, as described above, as implemented in a chamber heating system which is a dry-heat sterilizer. It should be understood that various sterilizers which do not operate by heating may also implement sterilization cycles, but non-dry sterilization cycles, such as those operating by steam heating, do not constitute dry-heat sterilization cycles.

Alternatively, to transfer heat throughout a chamber 300, the electronic controller of the chamber heating system can be configured to operate a pressure control cycle to pressurize a chamber and to depressurize a chamber.

Steam sterilization is based on pressurizing and depressurizing a chamber to direct steam that has been heated, in conjunction with powering a heating element and a ventilation assembly, to a temperature required for bacterial spore kill in contaminated articles. Steam saturated in this fashion can reach temperatures of at least 250° F. before a steam sterilizer pressurizes a chamber to direct the saturated steam into the chamber. Sterilizers can be configured to perform short steam sterilization cycles under 5 minutes in duration, commonly 2-3 minutes in duration. A “steam sterilization cycle” as described herein should be understood as a pressure control cycle implemented in a chamber heating system which is a steam sterilizer. Examples of steam sterilization cycles include gravity sterilization cycles, pre-vacuum sterilization cycles, and steam-flush pressure pulse sterilization cycles. In each type of steam sterilization cycle, pressurization over time reaches a maximum pressure to cause steam to fill a chamber and displace air from the chamber. Pressurization is then sustained over time to expose articles in the chamber to the saturated steam, and depressurization then releases steam from the chamber.

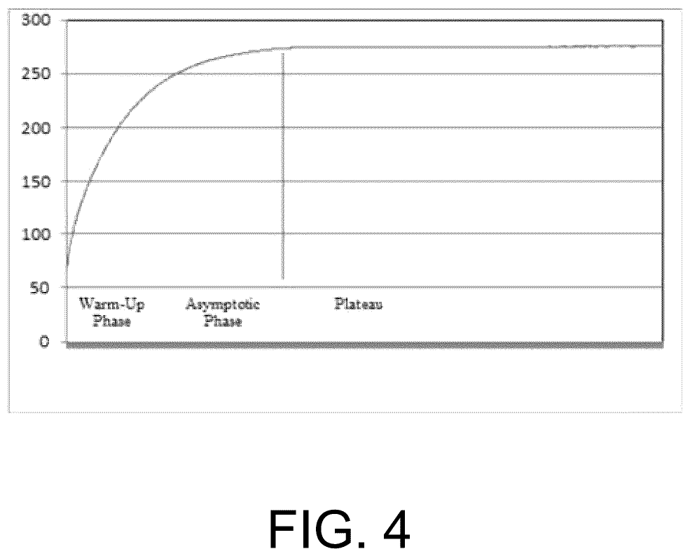

By way of illustration, FIG. 4 illustrates target article-localized temperature over three control phases of an electronic controller configured to operate a dry-heat chamber heating system from a cold start by powering and depowering a heating element to vary temperature over time. The vertical axis represents temperature (not yet sustained, and to be sustained, in the sterilization chamber over contaminated articles) in degrees Fahrenheit, and the horizontal axis represents time in seconds. The three phases are approximately delineated by vertical lines. Each control phase as shown herein can constitute a heat control cycle, such as a dry-heat sterilization cycle, and the combination of all control phases as shown herein can also constitute a heat control cycle or a dry-heat sterilization cycle.

Similarly, control phases of an electronic controller can be configured to operate a steam sterilizer chamber heating system from a cold start by powering and depowering a pressure valve to vary pressure over time in conjunction with powering a heating element and a ventilation assembly. According to gravity steam sterilization cycles, a first control phase gradually increases pressurization of a chamber to drive steam into a chamber. According to pre-vacuum sterilization cycles, a first control phase alternatingly pressurizes and depressurizes a chamber (forming a vacuum) to drive steam into a chamber and remove air from the chamber. According to steam-flush pressure pulse sterilization cycles, a first control phase alternatingly pressurizes and depressurizes a chamber (without forming a vacuum) to drive steam into a chamber. In each case, a first control phase is followed by a second control phase wherein pressurization is sustained to kill microorganisms by heat, which is followed by a third control phase releasing steam from the chamber.

Each individual control phase as described above, as well as combinations thereof, can respectively or in combination constitute a pressure control cycle, such as a steam sterilization cycle.

With reference to dry-heat control phases of FIG. 4, the electronic controller can be configured to operate in a first control phase which initiates article warmup, in which the controller computes a first PID feedback loop to sustain heating elements at an upper range of power. At approximately 30-35° F. below a target sterilization temperature, the controller can be configured to operate in a second control phase which finishes article warmup, in which the electronic controller computes a second PID feedback loop to reduce power to the heating elements, reducing the rate of temperature increase as article temperature asymptotically approaches the target temperature.

After the target temperature is approximately attained and article temperature has approximately plateaued, the electronic controller can be configured to operate in a third control phase to introduce air velocity modulation by controlling fan function to stabilize the temperature from any minor temperature increases or decreases that may occur during the remaining dry-heat sterilization cycle duration.

Likewise, with reference to steam sterilization cycles, the electronic controller can be configured to operate in a first control phase which induces article warmup, in which the controller computes a first PID feedback loop to pressurize a chamber, or to alternatingly pressurize and depressurize a chamber. At, or while approaching, a target sterilization temperature, the controller can be configured to operate in a second control phase which sustains article heating, in which the electronic controller sustains pressurization of a chamber. Thereafter, the controller can be configured to operate in a third control phase which cools and dries articles, in which the electronic controller depressurizes the chamber.

To achieve such distinct control phases, a high-heat wirelessly transmitting temperature sensor 100 can be positioned in a chamber 300 to measure article-localized temperatures, so that the computation of PID feedback loops is minimally impacted by any uneven, gradual distribution of heated air throughout the chamber 300 over time. The high-heat wirelessly transmitting temperature sensor 100 is configured to relay radio carrier signals to a data logger 200 as described above, while the data logger 200 is configured to relay temperature conversions, integrals of temperature conversions over a time period, and/or averages of temperature conversions over a time period to the electronic controller as described above, which the electronic controller uses as input to send power signals to power or depower one or more heating elements, or increase power, sustain power, or decrease power to one or more heating elements.

The wireless relaying of signals enables the high-heat wirelessly transmitting temperature sensor 100 to be positioned immediately adjacent to one or more articles to be heated within the chamber 300. As described above, articles to be heated can be sealed inside packaging. Articles to be heated can also have partially or fully enclosed structures containing pockets of air, thus obstructing heat conduction within these pockets of air. Articles to be heated can also be packed in close proximity within the chamber 300, thus forming narrow spaces where heat conduction is obstructed. According to example embodiments of the present disclosure, the high-heat wirelessly transmitting temperature sensor 100 can be sealed inside packaging alongside articles to be heated; can be positioned within partially or fully enclosed structures of articles to be heated; and can be positioned within narrow spaces between articles packed in close proximity. “Article-localized temperatures” according to example embodiments of the present disclosure can be measured from these enclosed or obstructed positions, without limitation thereto. Thus, article-localized temperatures can reflect temperatures at the immediate surface of articles to be heated, where heat conduction, due to enclosure or obstruction, may fall behind heat conduction elsewhere within the chamber 300, such that temperatures elsewhere in the chamber 300 may fail to reflect sterilization, cooking, curing (whether in the sense of food preservation, polymeric material treatment, vulcanization, and the like), drying, or otherwise exposure to heat at the immediate surface of articles.

Because the relayed temperature conversions are determined by measuring article-localized temperature inputs, control phases of an electronic controller are based on receiving localized input data with fine time granularity. For example, as described above, the data logger controller 202 can be configured to output approximately 15-20 temperature conversions, at an approximately regular interval, across a period of approximately 10 seconds. These temperature inputs can furthermore be averaged over the period of 10 seconds, while maintaining accuracy of measurement. Correspondingly, an electronic controller receives an accurate localized article-localized average temperature every 10 seconds, enabling the electronic controller to respond to a localized article-localized temperature trend which has furthermore been averaged to minimize irregular fluctuations or errors.

Furthermore, a heat control cycle, such as a dry-heat sterilization cycle according to example embodiments of the present disclosure, can be terminated by the electronic controller upon the electronic controller determining that heat output over the current cycle satisfies a cumulative heating specification. A cumulative heating specification according to example embodiments of the present disclosure is a measurement of total heat which should be output by heating elements of the chamber heating system over any length of time to sterilize, to cook, to cure (whether in the sense of food preservation, polymeric material treatment, vulcanization, and the like), to dry, or otherwise to expose to heat to a specified extent, all articles within the chamber 300.

A cumulative heating specification can be dependent upon a number of articles within the chamber 300, a mass of articles within the chamber 300, condition of articles within the chamber 300 (such as extent of contamination or extent of moisture), and the like. A cumulative heating specification can furthermore be dependent upon volumetric heat capacities of various materials within the chamber heating system, including air.

Based on such parameters, and based on the behavior of articles under a high-heat operating temperature range, a cumulative heating specification can be specified as amount of heat output required to sterilize, cook, cure, dry, or otherwise expose to heat some number of articles to a desired extent, or to further sterilize, cook, cure, dry, or otherwise expose to heat some number of articles to an additional extent permitting some degree of error.

According to example embodiments of the present disclosure, the electronic controller of the chamber heating system can be configured to compute heat output over the course of a heat control cycle such as a dry-heat sterilization cycle. The electronic controller can be configured to convert power output to a heating element to a heat output rate; to multiply a heat output rate by a length of time to derive heat output over the length of time; to sum heat outputs over any number of lengths of time; and to compare a sum of heat outputs to a cumulative heating specification. The electronic controller can be configured to, upon the sum of heat outputs reaching or exceeding the cumulative heating specification, terminate the heat control cycle, such as the dry-heat sterilization cycle.

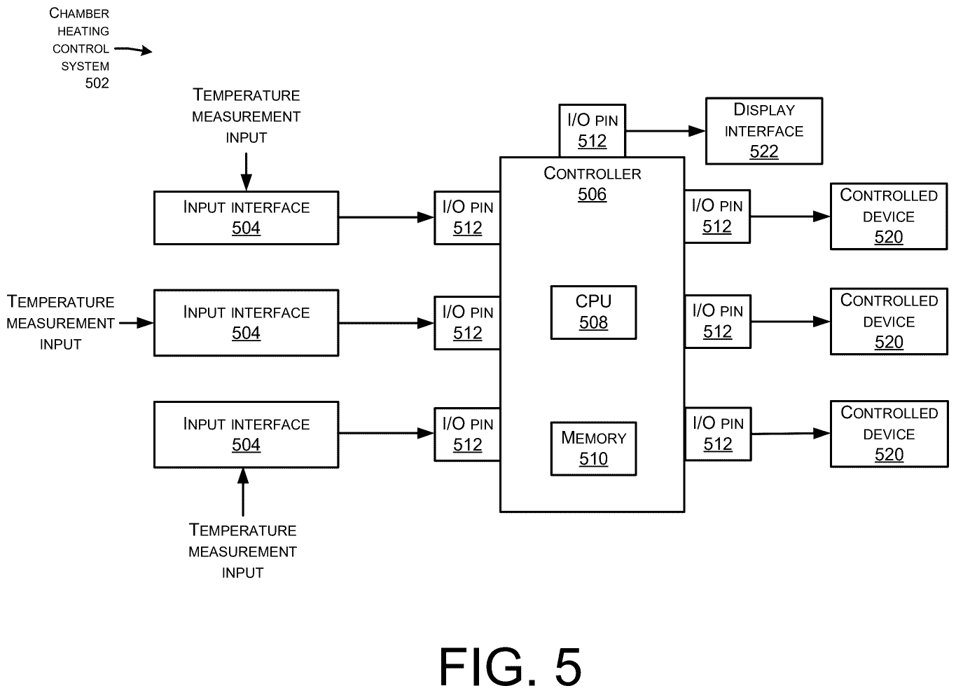

Unlike a heat control cycle, a pressure control cycle, such as a steam sterilization cycle according to example embodiments of the present disclosure, can run for a fixed duration of under 5 minutes, and commonly 2-3 minutes, without earlier termination. Instead, the electronic controller can determine steam-to-article contact upon the electronic controller determining that a constructed temperature-over-time profile matches or fails to match a target temperature-over-time profile. A steam-to-article contact determination can be computed and displayed as an article-localized heating progress on a display interface, as described subsequently with reference to FIGS. 5 through 7. A steam-to-article contact determination can be reported to indicate whether the pressure control cycle should be repeated.

According to example embodiments of the present disclosure, the electronic controller of a steam sterilizer chamber heating system can be configured to construct a temperature-over-time profile over the course of a pressure control cycle such as a steam sterilization cycle, based on temperature conversions, such as integrals of temperature conversions over a time period, and/or averages of temperature conversions over a time period relayed by the data logger 200. The electronic controller of the chamber heating system can be configured to match a constructed temperature-over-time profile against a target temperature-over-time profile. As steam sterilization prescribes sufficiently rapid rates of temperature increase within 2-3 minutes to contact contaminated articles with steam (and insufficient contact with steam may fail to kill microorganisms on contaminated articles within 2-3 minutes), a constructed temperature-over-time profile matching a target temperature-over-time profile can indicate steam-to-article contact, and a constructed temperature-over-time profile failing to match a target temperature-over-time profile can indicate lack of steam-to-article contact.

Thus, an article-localized heating progress according to example embodiments of the present disclosure can be displayed on a display interface by displaying success of steam-to-article contact; displaying lack of steam-to-article contact; displaying progression from lack of steam-to-article contact to success of steam-to-article contact over multiple points of time; displaying progression of lack of steam-to-article contact over multiple points of time; and the like.

For both a heat control cycle and a pressure control cycle, even while the electronic controller is receiving article-localized temperature inputs, depending on physical configuration, the heating elements of a chamber heating system are not necessarily article-localized. Furthermore, a chamber heating system tends to hold a temperature for some minutes after heating terminates. Thus, an electronic controller of a chamber heating system cannot necessarily be configured to adjust article-localized temperature.

If temperature sensing is implemented at a single location within the controlled space, best control is achieved only locally in the volume surrounding the sensor location, and control quality is poorer in other locations. Such implementations commonly result in overshoot and undershoot of the target temperature, and temperature is more coarsely controlled with increasing distance from the control sensor. Moreover, control in localized volumes within the controlled chamber affects the quality of control of temperature at these other localized sites, due to shadowing (in the case of radiant heating), and due to thermal mass effects upon time-to-heat.

Therefore, an electronic controller according to example embodiments of the present disclosure can be configured to output sufficient heat, then terminate the heat control cycle, such as the dry-heat sterilization cycle, after having sterilized, cooked, cured, dried, or otherwise exposed to heat some number of articles to a desired extent as specified by a cumulative heating specification. Alternatively, an electronic controller can be configured to operate a pressure control cycle for a fixed duration, then determine steam-to-article contact.

Sterilization processes should take into account worst-case conditions of size, and location within the working chamber, of items to be sterilized. Therefore, sterilization cycle times are established to ensure that sterilization goals are met for the worst case, typically including an amount of time that is added as a safety factor to provide high confidence in sterilization process results. Uniform temperature distribution, and precise measurement of temperature, are desired in sterilization, because optimization of these details results in ability use cycle times that would otherwise be extended in order to make allowance for the coolest or slowest-heating spaces within the system. Thus, uniform temperature distribution, and precise measurement of temperature, enable improved time-efficiency of the operation of such systems.

In practice, uniform temperature distribution and precise measurement of temperature are challenged by varying geometries of inner dimensions of a chamber heating system; varying configurations for loading a chamber heating system; loaded articles which are massive, having hollow segments, or being contaminated with excessive bioburdens of microorganisms; and the like. By configuring an electronic controller of the chamber heating system in fashions as described above, sufficiency of heating to achieve a function of a dry-heat chamber heating system can be determined, and the determination of sufficient heat output by the electronic controller can be made precise by article-localized temperature inputs, reducing the length of a heat control cycle, such as a dry-heat sterilization cycle. Alternatively, steam-to-article contact to achieve a function of a steam sterilizer chamber heating system can be computed and displayed on a display interface as an article-localized heating progress, and the determination of steam-to-article contact by the electronic controller can be made precise by article-localized temperature inputs, so that operators of a steam sterilizer chamber heating system can prevent contaminated articles from reentering service prior to contact with steam.

It should be understood that FIG. 4 illustrates only one example of control phases of an electronic controller of a dry-heat chamber heating system. Depending on intended purposes of various chamber heating systems, control phases can be designed to achieve various combinations of temperature increase, temperature maintenance, and/or temperature decrease, to various temperature specifications, at various times. By way of example, the electronic controller can be configured to compute, based on temperature conversions, integrals of temperature conversions over a time period, and/or averages of temperature conversions over a time period relayed from the data logger, as well as respective timestamps corresponding to each temperature conversion, a rate of temperature change, and can be configured to increase a rate of temperature change, sustain a rate of temperature change, or decrease a rate of temperature change (where temperature change can be positive or negative), instead of, or in addition to, increasing a temperature, sustaining a temperature, or decreasing a temperature.

FIG. 5 illustrates a chamber heating monitoring system 502 according to example embodiments of the present disclosure. A chamber heating monitoring system 502, according to example embodiments of the present disclosure, can include one or more sets of computer-readable instructions executable by a controller to perform tasks that include collecting an input from multiple input sources, the input including parameters and measurements; computing an article-localized heating progress according to the input; displaying an article-localized heating progress on a display interface; computing input parameters and measurements according to one or more feedback loops described by the computer-readable instructions to derive multiple control signals; and outputting control signals to multiple controlled devices 520, including at least a power signal to a ventilation assembly, a power signal to a heating element, and a power signal to an RF source.

A chamber heating monitoring system 502 may be a computing system integrated into a chamber heating system as described herein, or may be a separate computing system electronically coupled to a chamber heating system as described herein, where examples of a computing system according to example embodiments of the present disclosure as shall be described subsequently with reference to FIG. 6. Without reiterating the subsequent description, it should be understood, for the purpose of understanding example embodiments of the present disclosure, that the chamber heating monitoring system 502 can include various input interfaces and input devices, including one or more input interfaces 504 (such as receiving antennas) configured to receive transmission from a data logger as described above over a communication bus, a wired or wireless network connection, and the like, and can include a display interface 522, which can be any human-readable display apparatus, such as a display screen or monitor.

The controller 506 may be configured to process input from each of the input interfaces and temperature sensors, including a temperature input from one or more input interfaces 504.

The controller 506 can be configured as a PID controller using a temperature setting as a setpoint of a feedback loop. A setpoint, in the context of a PID controller, should be understood as a desired value of a variable, the PID controller being configured to substantially sustain that value of the variable in a feedback loop by sending control signals to one or more controlled devices 520 and obtaining feedback variable values from further input signals. According to example embodiments of the present disclosure, a setpoint can be a temperature setpoint, desired by an operator to configure the PID controller to substantially sustain in a chamber 300 as described herein. According to example embodiments of the present disclosure, the controller 506 can be configured as a PID controller which can substantially sustain the temperature input at approximately the value of the temperature setpoint (to within approximately 1-2° F.) by sending power signals to heating elements and a ventilation assembly, or by sending power signals to a pressure valve, and which can obtain feedback temperature conversions, integrals of temperature conversions over a time period, and/or averages of temperature conversions over a time period from the data logger as described above.

The controller 506 can be configured as a PID controller by the one or more sets of computer-readable instructions stored on a computer-readable storage medium. By way of example, the controller 506 can be a universal process controller or a programmable process controller, each being an example of a microcontroller, i.e., an integrated circuit composed of at least one or more central processing units (“CPUs” 508), memory 510, and some number of input/output (“I/O”) pins 512. Input interfaces 504 can each be coupled to an input/output pin 512.

Memory of the controller 506 can store one or more set of computer-readable instructions which configure the controller 506 to operate at least a feedback loop by performing a PID computation of one or more input signals, a proportional term, an integral term, a derivative term, and a setpoint to output one or more control signals.

Furthermore, a controller 506 can be configured to perform PID computation so as to avoid integral term windup.

The controller 506 can operate a first feedback loop by PID computing a first input signal, which can be a temperature input signal received from the data logger, along with a proportional term, an integral term, a derivative term, and a setpoint, outputting, respectively, a power signal for a heating element, and a power signal to a ventilation assembly, or outputting a power signal for a pressure valve.

The proportional term, the integral term, and the derivative term can each be configured such that, while a temperature input signal represents a value lower than the setpoint, the PID computations can result in a power signal sustaining power to a respective heating element (to induce further heat dissipation at a present rate at a location of an article-localized temperature), and can result in a power signal sustaining power to a ventilation assembly (to induce fluid shear and mechanical heat at a location of an article-localized temperature), or can result in a power signal sustaining power to a pressure valve (to pressurize a chamber 300).

The proportional term, the integral term, and the derivative term can each be configured such that, while a temperature input signal represents a value higher than the setpoint, the PID computations can result in a power signal reducing power to a respective heating element (to induce further heat dissipation at a reduced rate to the location of the article-localized temperature), and can result in a power signal reducing power to a ventilation assembly (to induce fluid shear and mechanical heat at a reduced rate to the location of the article-localized temperature), or can result in a power signal reducing power to a pressure valve (to depressurize a chamber 300).

The proportional term, the integral term, and the derivative term can each be configured such that, while a temperature input signal represents a value within 1-2° F. of the setpoint, the PID computations can result in a power signal sustaining, or periodically increasing and decreasing, power to a respective heating element (to induce further heat dissipation at a stably sustained rate, or at a stably oscillating rate, to the location of the article-localized temperature), and can result in a power signal sustaining, or periodically increasing and decreasing, power to a ventilation assembly (to induce fluid shear and mechanical heat at a stably sustained rate, or at a stably oscillating rate, to the location of the article-localized temperature), or can result in a power signal periodically increasing and decreasing power to a pressure valve (to alternatingly pressurize and depressurize a chamber 300).

The controller 506 can be further configured to sustain temperature at approximately the value of a temperature setpoint. For dry-heat chamber heating systems, the controller 506 can sustain temperature based on deriving a cumulative reduction of microorganism population contaminating an article, subsequently referred to as “a cumulative number of article-localized log-kills,” from a D-value. It should be understood that “D-value,” also called “decimal reduction time,” refers to a length of time (measured in minutes) required to sustain a condition (in this case, a high-heat temperature) to reduce a microorganism population to one-tenth of its original population (therefore achieving “log-kill,” or elimination of 1 log or 90% of the population). D-values and log-kill may or may not be specific to microorganism populations contaminating a specific article, depending on whether they are computed from article-localized temperatures.

D-values are specific to different microorganism species; specific to environmental conditions; and specific to temperatures. By way of example, over a high-heat operating temperature range, higher temperatures correlate to lower D-values. Based on a known microorganism species and a known environment (such as a particular model of chamber heating system), a controller 506 can compute article-localized D-value from an article-localized temperature measurement alone. In contrast, temperatures elsewhere in a chamber 300 would not necessarily be indicative of article-localized D-values, as temperatures elsewhere may reduce microorganism population elsewhere in the chamber 300, but do not necessarily fully contribute to reducing microorganism population contaminating an article.

Therefore, the controller 506 can be configured to, based on a temperature input signal received from the data logger, compute an article-localized D-value at any time during a heat control cycle, such as a dry-heat sterilization cycle, as follows:

The controller 506 reads consecutive article-localized temperature input signals received from the data logger at sequential periods of approximately one second each, thus deriving a time series of article-localized temperatures per second. Alternatively, the controller 506 reads consecutive article-localized temperature input signals received from the data logger at sequential periods of longer than one second each, and computes average article-localized temperatures for each of multiple sequential periods of approximately one second each, thus deriving a time series of temperatures per second.

According to example embodiments of the present disclosure, the time series of article-localized temperatures per second can be limited to only temperatures at or higher than 240 degrees Fahrenheit.

The controller 506, based on a microorganism-specific and heating system-specific scale correlating temperatures to article-localized D-values, converts each article-localized temperature of the time series to a respective microorganism-specific and heating system-specific article-localized D-value, thus deriving a time series of article-localized D-values per second.

Based on the article-localized D-value, the controller 506 further computes a cumulative number of article-localized log-kills over the total time at which the article-localized temperature represented by the temperature input signal has been sustained, as follows:

Across the time series of temperatures per second, the controller 506 computes a product of each article-localized D-value over a respective span of time (each span of time measured in minutes), therefore deriving a series of article-localized log-kills achieved over time. By summing the series of article-localized log-kills, the controller 506 computes a cumulative number of article-localized log-kills.

For each different temperature, the controller 506 can be configured to compute a cumulative number of article-localized log-kills.

The controller 506 can display, on a display interface 522, an article-localized heating progress according to example embodiments of the present disclosure by displaying a cumulative number of article-localized log-kills, as illustrated in the display interface of FIG. 6A, and a threshold of log-kills, as illustrated in the display interface of FIG. 6B. A cumulative number of article-localized log-kills can be periodically refreshed on the display interface 522 for comparison to a threshold of log-kills as illustrated in the display interface of FIG. 6B, or can be periodically added to a graphical trending illustration of a cumulative number of article-localized log-kills over time, as illustrated in FIGS. 6C and 6D.

After the controller 506 computes cumulative numbers of article-localized log-kills totaling a threshold exceeding 12 log, such as, by way of example, 14 log (to permit some degree of error), the controller 506 can cease to sustain temperature at a temperature setpoint by depowering a heating element or depowering a pressure valve, and the controller 506 can terminate the heat control cycle, such as the dry-heat sterilization cycle, at any time.

Alternatively, for steam sterilizer chamber heating systems, the controller 506 can sustain temperature based on a preset setpoint for a fixed duration.

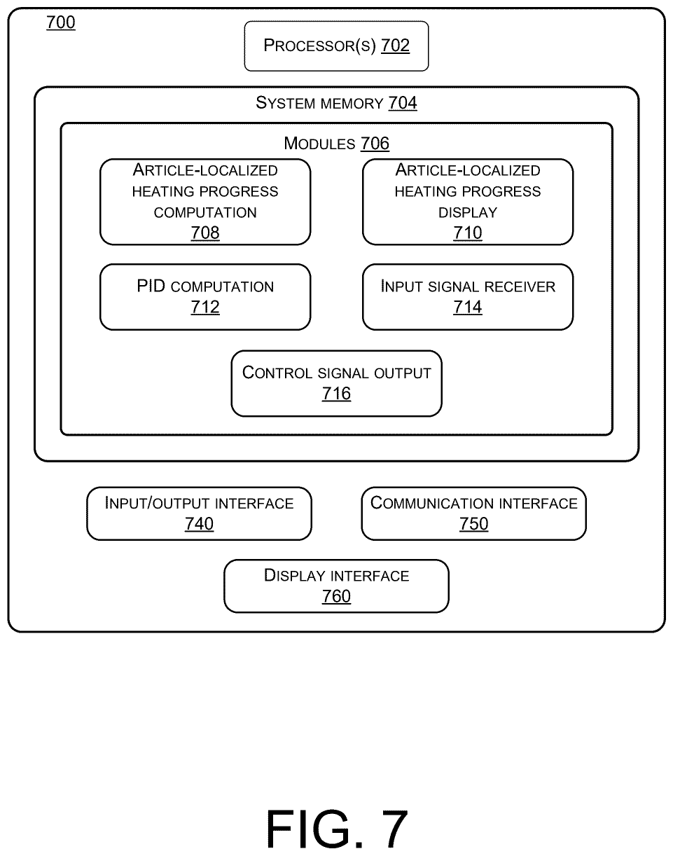

FIG. 7 illustrates an example system 700 for implementing the processes and methods described above for implementing temperature control.

The techniques and mechanisms described herein may be implemented by multiple instances of the system 700, as well as by any other computing device, system, and/or environment. The system 700 shown in FIG. 7 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 700 may include one or more processors 702 and system memory 704 communicatively coupled to the processor(s) 702. The processor(s) 702 may execute one or more modules and/or processes to cause the processor(s) 702 to perform a variety of functions. In embodiments, the processor(s) 702 may include a central processing unit (“CPU”), a graphics processing unit (“GPU”), both CPU and GPU, or other processing units or components known in the art. Additionally, each of the processor(s) 702 may possess its own local memory, which also may store program modules, program data, and/or one or more operating systems.

Depending on the exact configuration and type of the system 700, the system memory 704 may be volatile, such as RAM, non-volatile, such as ROM, flash memory, miniature hard drive, memory card, and the like, or some combination thereof. The system memory 704 may include one or more computer-executable modules 706 that are executable by the processor(s) 702.

The modules 706 may include, but are not limited to, an article-localized heating progress computation 708, an article-localized heating progress display 710, a PID computation 712, an input signal receiver 714, and a control signal output 716.

The article-localized heating progress computation 708 can configure one or more processors to compute an article-localized heating progress as described above with reference to FIGS. 3 and 5.

The article-localized heating progress computation 710 can configure one or more processors to display an article-localized heating progress on a display interface 522 as described above with reference to FIGS. 3 and 5.

The PID computation 712 can configure one or more processors to PID compute a feedback loop as described above with reference to FIG. 5.

The input signal receiver 714 can configure one or more processors to receive one or more input signals as described above with reference to FIG. 5.

The control signal output 716 can configure one or more processors to send one or more control signals, including at least a power signal, as described above with reference to FIG. 5.

The system 700 may additionally include an input/output (I/O) interface 740, a communication module 750 allowing the system 700 to communicate with other systems and devices over a network, and a display interface 760, which can be any human-readable display apparatus, such as a display screen or monitor. The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer-readable storage media do not include communication media.

The computer-readable instructions stored on one or more non-transitory computer-readable storage media that, when executed by one or more processors, may perform operations described above with reference to FIGS. 1 to 6D. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A temperature sensor, comprising:
an oscillator;
a transmitting antenna; and
a wireless power harvester.

2. The temperature sensor of claim 1, wherein the oscillator comprises a first passive electronic component having higher inductance than either resistance or capacitance, and a second passive electronic component having higher capacitance than either resistance or inductance.

3. The temperature sensor of claim 2, wherein respective characteristic frequencies of the first passive electronic component and the second passive electronic component have temperature dependencies such that a temperature difference of approximately one degree Celsius across a range of approximately 120 to 250 degrees Celsius corresponds to a difference in characteristic frequency having an order of magnitude of 10 hertz or more.

4. The temperature sensor of claim 1, wherein the oscillator comprises one or more transistors operable at up to approximately 120 to 300 degrees Celsius.

5. The temperature sensor of claim 1, wherein the transmitting antenna is configured to transmit an oscillating electric signal of the oscillator as a radio carrier signal.

6. The temperature sensor of claim 5, further comprising one or more signal-modulating transistors configured to modulate the radio carrier signal.

7. The temperature sensor of claim 1, wherein the oscillator comprises a resonator having a temperature-dependent characteristic frequency.

8. The temperature sensor of claim 1, wherein the wireless power harvester comprises a power harvesting antenna and a rectifier.

9. The temperature sensor of claim 8, wherein the power harvesting antenna comprises a coreless inductor configured to passively store electric energy in an electromagnetic field.

10. The temperature sensor of claim 9, wherein the coreless inductor comprises a planar spiral coiled wire configured to carry an alternating current.

11. The temperature sensor of claim 8, wherein the rectifier comprises a polyphase rectifier.

12. A chamber heating monitoring system, comprising:
a controller configured to receive an article-localized temperature input signal from a data logger; and
a display interface;
wherein the controller is configured to:
compute an article-localized heating progress based on the article-localized temperature input signal; and
display the article-localized heating progress on the display interface.

13. The chamber heating monitoring system of claim 12, wherein computing an article-localized heating progress comprises:
computing a cumulative number of article-adjacent log-kills over a total time based on the article-localized temperature input signal.

14. The chamber heating monitoring system of claim 12, wherein computing an article-localized heating progress comprises:
constructing a temperature-over-time profile based on the article-localized temperature input signal; and
determining steam-to-article contact by determining that the constructed temperature-over-time profile matches or fails to match a target temperature-over-time profile.

15. A chamber heating system, comprising:
a chamber;
a heating element;
an electronic controller configured to send a plurality of control signals to increase or decrease power draw to the heating element; and
a wireless temperature sensor positioned within the chamber;
wherein the electronic controller is configured to operate a heat control cycle according to one or more feedback loops to derive the plurality of control signals, wherein operating the heat control cycle comprises processing input from the wireless temperature sensor.
